(19) United States
(12) Patent Application Publication
(10) Pub. No.: US 2026/0235785 A1
(43) Pub. Date: Aug. 13, 2026

(54) A HYBRID SERS SUBSTRATE AND METHOD OF FORMING THE SAME

(71) Applicant: Agency for Science, Technology and Research, Singapore (SG)

(72) Inventors: Meng Zhao, Singapore (SG); Jinghua Teng, Singapore (SG); Qing Yang Steve Wu, Singapore (SG); Nan Zhang, Singapore (SG); Xian Wei Chua, Singapore (SG); Yi Fan Chen, Singapore (SG); Sreekanth Kandammathe Valiyaveedu, Singapore (SG); Jayakumar Perumal, Singapore (SG); Dinish Unnimadhava Kurup Soudamini Amma, Singapore (SG); Malini Olivo, Singapore (SG)

(21) Appl. No.: 19/469,564

(22) PCT Filed: Mar. 4, 2024
(86) PCT No.: PCT/SG2024/050130

§ 371 Date: Sep. 26, 2025

(30) Foreign Application Priority Data
Mar. 27, 2023 (SG) 10202300823X

(51) Int. Cl. G02B 1/00; B82Y 20/00; B82Y 40/00; G01N 21/65; G02B 5/00

(52) U.S. Cl. CPC G02B 1/002; B82Y 20/00; B82Y 40/00; G01N 21/658; G02B 5/008

(57) ABSTRACT

A SERS substrate includes: a base, an array of nanostructures formed on the base, a first coating disposed on the array of nanostructures, and a second coating disposed on the first coating. The first coating includes a thin film formed of a noble metal. The second coating includes a metallic/semimetallic two-dimensional material. The metallic/semimetallic two-dimensional material may include one or more transition metal dichalcogenides. A method of making a SERS substrate include: plasma etching a base to form an array of nanostructures on the base; forming a first coating on the array of nanostructures, the first coating being a thin film formed of a noble metal; and forming a second coating on the first coating. The method may further include: forming a plurality of two-dimensional flakes using electrochemical exfoliation; and depositing the plurality of two-dimensional flakes after the first coating is formed.

### RELATED APPLICATION

This application claims the benefit of priority to the Singapore application no. 10202300823X filed Mar. 27, 2023, the contents of which are hereby incorporated by reference in their entirety for all purposes.

### TECHNICAL FIELD

The present application relates to Surface Enhanced Raman Scattering (SERS), and more particularly to substrates for use in SERS-based sensing and methods of making the substrates.

### BACKGROUND

Surface Enhanced Raman Scattering (SERS) is a promising technique for various molecule-sensing applications. It is generally believed that the mechanism of SERS is primarily based on an electromagnetic (EM) mechanism, i.e., involving local field enhancement arising from plasmonic resonances of noble metal nanostructures. As such, there have been various methods proposed for fabricating nanostructures to take advantage of inelastic light scattering by molecules absorbed on nanostructured surfaces, e.g., bottom-up self-assembly.

The bottom-up self-assembled nanostructures generally suffer from a non-uniform field distribution, resulting in SERS signals with low reproducibility (e.g., high spatial variation and high temporal variation), especially for low-concentration detection. An example of high spatial variation includes the presence of highly confined hotspots in the SERS substrate. This problem is aggravated in the sensing of relatively large biomolecules.

Chemical mechanism (CM) is another possible SERS mechanism. CM involves charge transfer between the SERS substrate and probe molecules adsorbed on the SERS substrate. Large-scale production of SERS substrates at a quality level suitable for practical applications of CM-based SERS is a great challenge. Physical methods, including chemical vapor deposition (CVD) growth and mechanical exfoliation, used in research are generally suitable only for laboratory-scale experiments. Mechanical exfoliation, for example, involves repetitiously applying a piece of Scotch tape to bulk material and carefully peeling off the Scotch tape to lift off a flake of the material. It can be appreciated that it would not be feasible to scale up such methods for manufacturing or practical applications.

### SUMMARY

In one aspect, various embodiments of the present disclosure include a SERS substrate. The SERS substrate includes: a base, an array of nanostructures formed on the base, a first coating disposed on the array of nanostructures, and a second coating disposed on the first coating. The first coating includes a thin film formed of a noble metal. The second coating includes a metallic/semimetallic two-dimensional material. The metallic/semimetallic two-dimensional material may include one or more transition metal dichalcogenides.

According to another aspect, in various embodiments, a method of making a SERS substrate includes steps of: plasma etching a base to form an array of nanostructures on the base; forming a first coating on the array of nanostructures, the first coating being a thin film formed of a noble metal; and forming a second coating on the first coating, in which the second coating includes a metallic/semimetallic two-dimensional material. The metallic/semimetallic two-dimensional material may include one or more transitional metal dichalcogenides.

The method may include plasma etching the array of nanopillars from a silicon wafer. The method may include forming the thin film is formed by electron beam evaporation. The method may further include: forming a plurality of two-dimensional flakes using electrochemical exfoliation; and depositing the plurality of two-dimensional flakes after the first coating is formed.

### BRIEF DESCRIPTION OF THE DRAWINGS

Various embodiments will be described with reference to the following figures:

FIG. 1 is a schematic diagram illustrating a SERS substrate and a method of making thereof, according to embodiments of the present disclosure;

FIG. 2A is an optical image of a 4-inch silicon nanopillar (SNP) substrate;

FIG. 2B is a scanning electron microscope (SEM) image corresponding to the optical image of the substrate of FIG. 2A;

FIG. 3A to FIG. 3D are SEM images of substrates with SNP coated with silver to different thicknesses;

FIG. 4 shows Raman spectra of naphthalenethiol on SNP substrates coated with silver to different thicknesses;

FIG. 5 shows the SERS performance of a bare SNP substrate and a SNP substrate coated with silver;

FIG. 6A and FIG. 6B are optical images of exfoliated two-dimensional TaS2 flakes;

FIG. 6C is an XRD of tantalum disulfide (TaS2) crystal;

FIG. 6D is a transmission electron microscope selected area (electron) diffraction (TEM-SAED) pattern of the as-exfoliated TaS2 flakes;

FIG. 7 shows the SERS performance of SNP substrates with and without TaS2 coating, performed with mild laser intensity; and FIG. 8 shows the SERS performance of substrates of FIG. 7, performed with strong laser intensity.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

The word “exemplary” is used herein to mean “serving as an example, instance, or illustration.” Any embodiment described herein as “exemplary” is not necessarily to be construed as preferred or advantageous over other embodiments. As used herein, the singular ‘a’ and ‘an’ may be construed as including the plural “one or more” unless apparent from the context to be otherwise.

Terms such as “first” and “second” are used in the description and claims only for the sake of brevity and clarity, and do not necessarily imply a priority or order, unless required by the context. The terms “about” and “approximately” as applied to a stated numeric value encompasses the exact value and a reasonable variance as will be understood by one of ordinary skill in the art, and the terms “generally” and “substantially” are to be understood in a comparable manner, unless otherwise specified.

Some methods may be described in terms of steps merely to aid understanding and/or for convenient reference. The delineation between one step and another step may be merely for convenient reference in the present disclosure. It will be understood that in actual implementation there may not be a clear division or transition from one step to another subsequent step. There may be a certain amount of overlap among the steps and/or more than one step may occur or be performed concurrently in time, etc.

In the present disclosure, unless otherwise dictated by the context, the terms “substrate” and “SERS substrate” may be used interchangeably to refer to a device suitable for use as a sensor or as a part of a sensor involving surface-enhanced Raman scattering-related mechanisms for signal generating and/or enhancing. The SERS substrate of the present disclosure may be referred to as a hybrid SERS substrate as it is operable by more than one SERS mechanism, e.g., a combination of EM and CM. Nevertheless, this does not prevent the SERS substrate from being used in applications where essentially only one SERS mechanism is effective.

### SERS Substrate

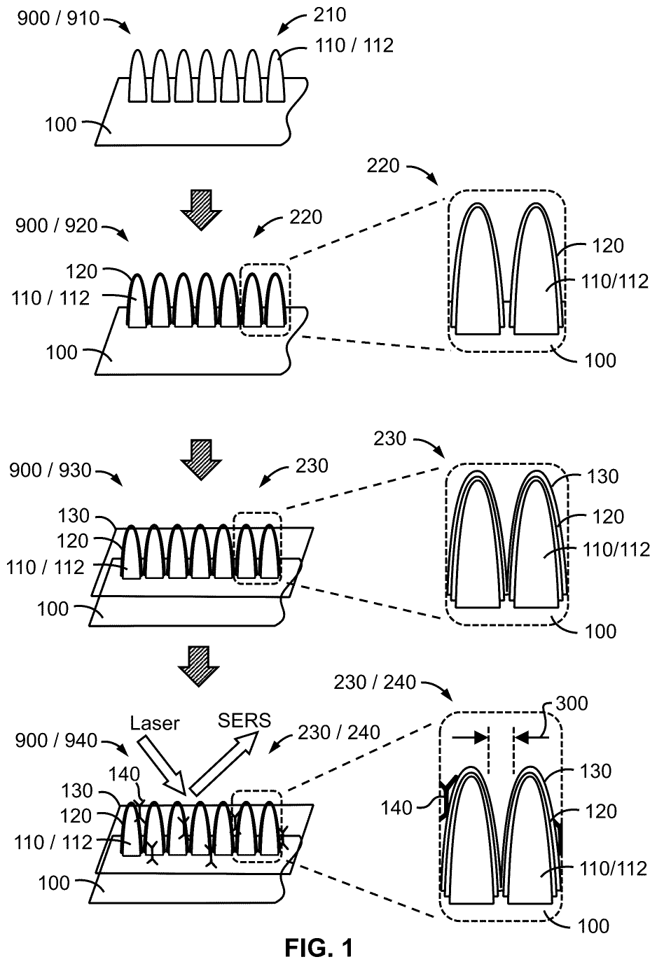

FIG. 1 is a schematic diagram illustrating a SERS substrate 230 and a method 900 of making thereof, according to various embodiments of the present disclosure.

The SERS substrate 230 according to embodiments of the present disclosure includes a plurality of three-dimensional nano-sized structures 110 (also referred to as “nanostructures” 110 for the sake of brevity) with a first coating 120 formed on/over the nanostructures 110 and a second coating 130 formed on/over the first coating 120, in which the first coating 120 includes a noble metal and the second coating 130 includes a metallic/semimetallic two-dimensional material. For example, the second coating 130 may include, but is not limited to, one or more transition metal dichalcogenides.

The SERS substrate 230 according to embodiments of the present disclosure includes a distributed plurality of nanostructures 110 with at least two coatings of different materials. The SERS substrate 230 includes an inner coating (“the first coating”) 120 of a metal interposed between the nanostructure base material and an outer coating (“the second coating”) 130 of a metallic/semimetallic two-dimensional materials. For example, the second coating may include, but is not limited to, one or more transition metal dichalcogenides.

The SERS substrate 230 may be described as a hybrid SERS substrate with nanostructures 110 coated with a first coating 120 and a second coating 130, in which the first coating 120 facilitates the electromagnetic mechanism of SERS and in which the second coating 130 facilitates the chemical mechanism of SERS. In some examples, sensing molecules 140 such as dye molecules are adsorbable to the second coating 130.

In some embodiments, the SERS substrate 230 includes a plurality of nanostructures 110 distributed in an array 210 over a substantially planar base 100. In some examples, the base 100 may be a wafer. In some examples, the base 100 may be a silicon wafer such that SERS substrates 230 of the present disclosure may be mass manufactured at the wafer scale. The ability to manufacture SERS substrates 230 at the wafer scale advantageously enables the use of existing wafer fab facilities and economies of scale for the production of a device that was previously confined to laboratory-scale fabrication (e.g., one sample at a time).

In the following description, the embodiments may be described in terms of nanostructures 110 including silicon nanopillars (SNP) 112. The SNP 112 may be integrally formed with a silicon wafer base. For example, SNP may be formed by plasma etching of a silicon wafer. It will be understood that the nanostructures 110 may be provided in any of various non-metallic materials, shapes, and sizes, with dimensions in the nanoscale. For example, in some embodiments, the nanostructure 110 may be a conically-shaped or columnarly-shaped protrusion (also referred to as a “nanopillar”). The nanostructure 110 may be characterized by a height dimension and a width (or diameter) dimension in the nanoscale, in which each dimension is smaller than 1000 nm. In some examples, the diameter of each nanostructure may be in a range from 100 nm to 500 nm (e.g., from about 100 nm to about 500 nm). The height of each nanostructure may be in a range between 600 nm to 800 nm (e.g., from about 600 nm to about 800 nm). The nanostructures 110 form a monodisperse array 210 characterized by a generally or approximately similarly-sized spacing between the nanostructures. In some examples, the array of nanostructures includes a monodisperse array 210 in which the nanogap 300 or the spacing (between adjacently disposed nanostructures) is less than 500 nm (e.g., less than about 500 nm).

In some embodiments, the first coating 120 includes a noble metal thin film. For example, the first coating 120 may be a thin film excitable into plasmonic resonances, contributing to local field enhancement in SERS. In some embodiments, the first coating 120 includes essentially a silver (Ag) thin film such that the SERS substrate 230 includes an array of silver-coated SNP (denoted as “SNP-Ag”) 220. In some embodiments, the first coating 120 includes essentially a gold (Au) thin film. Alternatively, in some embodiments, the first coating 120 includes essentially a copper (Cu) thin film.

In some embodiments, the second coating 130 includes a two-dimensional material deposited on/over the coated nanostructures 220 (e.g., nanostructures coated with the first coating). In some embodiments, the second coating 130 includes a plurality of two-dimensional flakes of various sizes and shapes, each of one or a few layers of molecules, randomly distributed to cover most if not all of the area coated by the first coating. The second coating 130 may form a contiguous or substantially contiguous covering over the first coating 120. The resulting SERS substrate 230 may include one or more local areas in which the first coating is exposed, e.g., not covered by the second coating 130. As used herein, the term “two-dimensional” (or “2D”) may refer to a piece of material consisting of only a single layer of molecules or consisting of only a few layers of molecules.

In some embodiments, the second coating 130 includes a metallic 2D material. As used herein, the term “metallic material” or “metallic” may include one or more materials generally referred to as “metallic” and/or “semimetallic”, e.g., including materials with superconducting properties. For the sake of brevity, the second coating 130 may also be described as including a metallic/semimetallic 2D material. In some embodiments, the metallic/semimetallic 2D material includes one or more transition metal dichalcogenides (TMDCs) and/or other metallic/semimetallic materials. In some embodiments, the second coating 130 may include but is not limited to (e.g., formed from/by) one or more of the following semimetallic materials: tantalum disulfide (TaS₂), niobium diselenide (NbSe₂), tungsten ditelluride (WTe₂), or other metallic 2D materials, etc. It will be understood that these exemplary materials are named merely to provide examples and to aid understanding. Upon perusal of the present disclosure, one of ordinary skill in the art would not require inventive effort to select another metallic/semimetallic material that may be available in two-dimensional form (i.e., metallic/semimetallic 2D material) for use as a part of or the whole of the second coating 130 as taught herein.

In some embodiments, the SERS substrate 230 may include dye molecules 140 provided on the second coating 130 to provide a customizable sensing platform 240, e.g., selected dye molecules may be adsorbed to the 2D flakes for detection of specific target molecules.

### Manufacturing Method

Still referring to FIG. 1, embodiments of the proposed method 900 will now be described, including embodiments suitable for implementation at a large scale or in mass manufacturing. For the sake of brevity, the method 900 will be described for a SERS substrate 230 having silver-coated silicon nanopillars 220 further coated with a second coating 130 of tantalum disulfide (SNP-Ag-TaS₂). It will nevertheless be understood that the SERS substrate disclosed herein is not limited to this specific example.

### Large Area SNP

Large area SNP 210 was fabricated in a first forming step 910, e.g., by a fluorine-based inductively coupled plasma (ICP-F based) blanket etching process. First, the p-type silicon substrate was cleaned with acetone in ultrasonic bathing for about five minutes, followed by rinsing with isopropyl alcohol (IPA) and deionized water (DI water). Dry etching was carried out on the silicon base using the Oxford Plasmalab 100 Cobra System (available from Oxford Instruments) to form silicon nanopillars (SNP). Sulfur hexafluoride (SF₆) and oxygen (O₂) were used as the reactive agents.

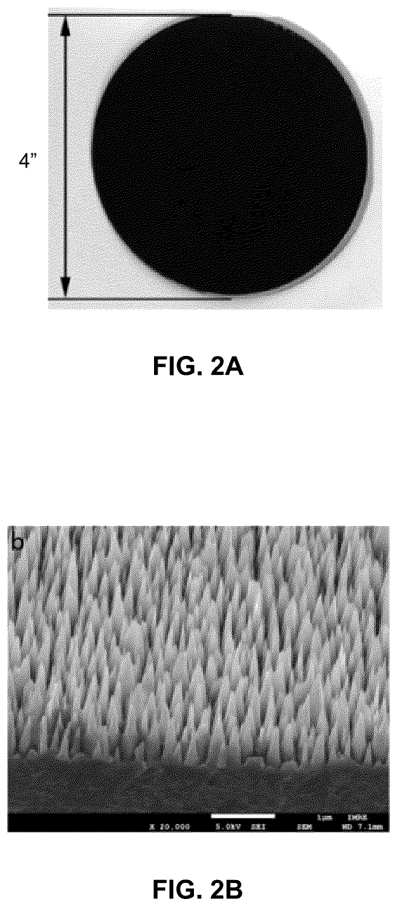

It was experimentally verified that the SNP can be fabricated in wafer scale at a relatively low cost. FIG. 2A is an optical image of an exemplary 4-inch wafer scale SNP substrate fabricated. The wafer appears in a dark color in the optical image owing to the presence of the nanostructures formed. A zoom-in (magnified) view of a scanning electron microscope (SEM) image of the SNP structures is shown in FIG. 2B. FIG. 2B clearly shows the nano-cone shape of the as-fabricated SNP. The relatively open structure of the as-fabricated SNP shows that suitable nanostructures (e.g., which can serve as a “hot spot” for enhanced electromagnetic field or enhanced SERS performance) can be formed at the wafer scale.

### SNP-Ag Structure

Subsequently, the array of as-fabricated SNP was coated in a first coating step 920 of the method 900 (see FIG. 1), e.g., the as-fabricated SNP may be coated with silver to further enhance its SERS performance. The silver nanoparticles can be deposited onto the silicon nanopillars in any one of various coating processes. Examples of suitable coating processes include but are not limited to dip-coating, spin coating, drop casting, screen printing, etc. It was experimentally verified that the electron beam evaporation process can be applied to obtain uniform or substantially uniform monodisperse nanoparticles of silver over the silicon nanopillars.

The proposed method therefore overcomes the challenge conventionally faced in achieving a monodispersed arrangement of nanoparticles with well-spaced between nanoparticles creating nanogaps. Advantageously, the proposed method can be carried out on a large scale suitable for mass production. In contrast, the conventional colloidal particle-based approach cannot be scaled up.

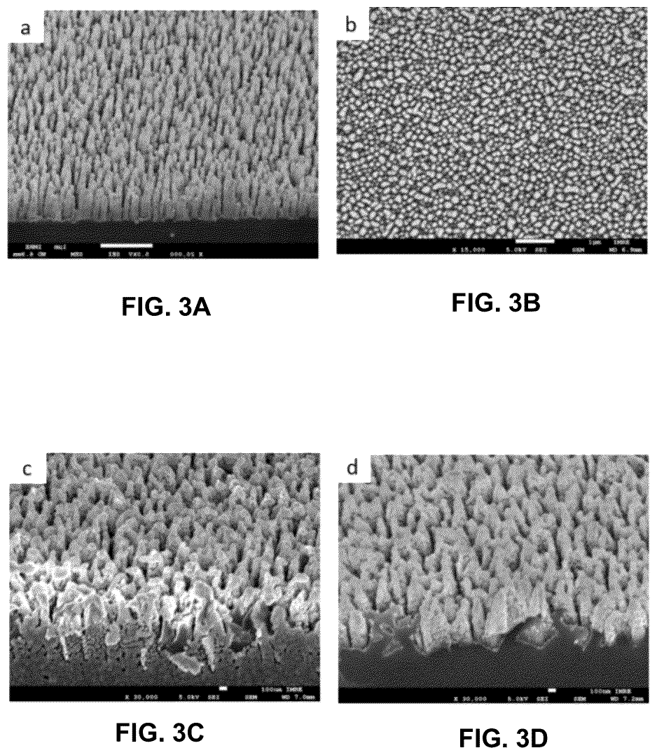

It was experimentally verified that it was possible to obtain a first coating of uniform monodisperse nanoparticles with different silver thicknesses over the nanopillars. A thin film deposition system (Denton Explorer available from Denton Vacuum) was used for the deposition of Ag with 1 A/sec deposition rate. FIG. 3A to FIG. 3D are SEM images of the SNP-Ag structure obtained with different silver thicknesses. FIG. 3A is a side view of SNP with a first coating of silver of thickness of 130 nm. FIG. 3B is a top view of the SNP-Ag of FIG. 3A. FIG. 3C shows SNP/Ag with a 90 nm thick first coating of silver. FIG. 3D shows SNP-Ag with a 110 nm thick coating of silver.

SERS performance was examined for these different SNP substrates. The SNP substrates were soaked in naphthalenethiol solution and then gently dried for Raman measurement.

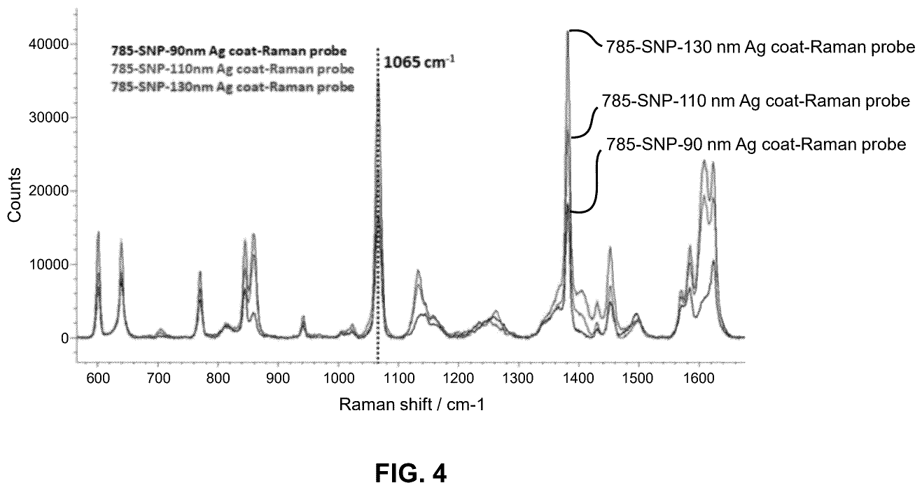

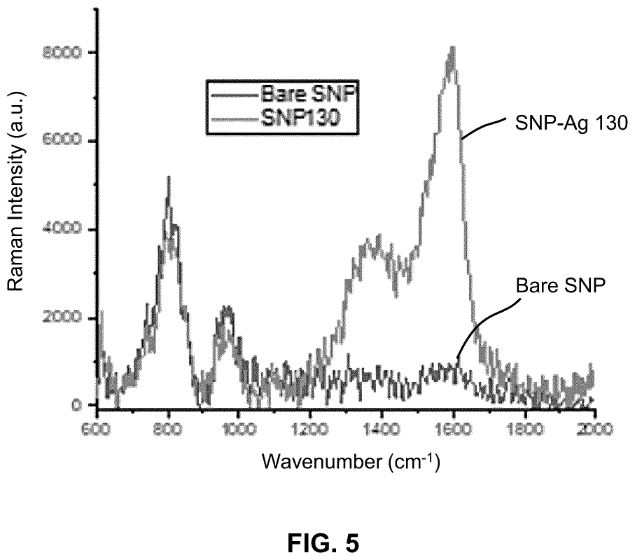

FIG. 4 shows the SERS performance of the SNP substrate coated with silver of different thicknesses. Among the samples, SNP-Ag with 130 nm silver coating gives the best signal of about 2.5 times higher than that of the 90 nm silver coating and about 1.5 times higher than that of the 110 nm silver coating. FIG. 5 shows that, compared with bare SNP (without the silver coating), the SERS performance in terms of Raman intensity was greatly enhanced with silver coating. In the examples studied, a silver coating thickness of 130 nm or about 130 nm produced the preferred SERS performance.

### Mass Production of High-Quality 2D Flakes by Electrochemical Exfoliation The following described further experiments based on samples of SNP-Ag with 130 nm thick silver coating.

Exfoliation of layered 2D flakes was carried out in a two-electrode system using an electrochemical process. In one example, a bulk TaS₂ crystal was fixed on a silver wire using copper tape as a cathode, with a platinum wire counter electrode serving as anode. The electrolyte was prepared by dissolving tetrabutyl ammonium tetrafluoroborate (TBABF₄) in propylene carbonate (PC) with a concentration of 0.01 M. A voltage of 4 V was applied to exfoliate the bulk TaS₂ crystal. Upon application of the voltage, there was rapid volumetric expansion of the bulk crystal. The bulk crystal gradually exfoliated into thin flakes within tens of minutes.

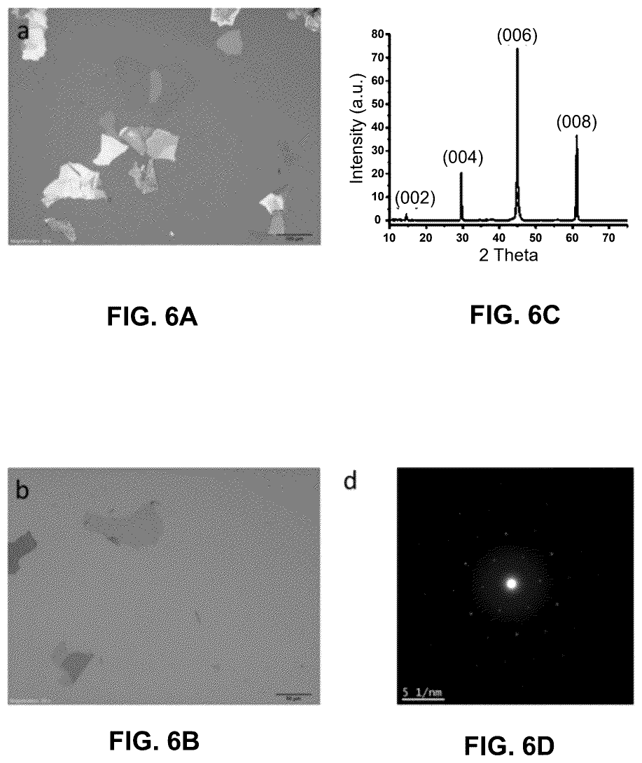

As shown in the optical images of FIG. 6A and FIG. 6B, the electrochemically exfoliated 2D flakes can be as large as 100 μm and as thin as 1 nm. FIG. 6C is an XRD image of the crystal, and FIG. 6D is a TEM-SAED pattern of the same. Both X-ray diffraction and selected area electron diffraction (SAED) using a transmission electron microscope (TEM) show that the 2D flakes obtained have a high crystallinity in the 2H phase. The results imply that 2D flakes obtained were in the form of 2H phase single crystals (also known as single crystalline flakes) suitable for the present purpose. In other words, the proposed method could produce relatively large area 2D flakes of the desired quality in large scale and at low cost. This advantageously paves the way for the use of the 2D materials in many practical applications.

With the proposed method, mechanical peeling is no longer necessary for the fabrication 2D flakes. Nonetheless, for the avoidance of doubt, it will be understood that 2D materials produced by mechanical peeling can also be used in small scale fabrication of the proposed SERS substrate, if so desired.

### SERS Performance of SNP/Ag/TaS2 Hybrid Structure

The second coating may be formed in a second coating step 930 of the method 900 (see FIG. 1), e.g., by a deposition process suitable for depositing 2D flakes over the area covered by the first coating.

In the experiments, TaS₂ from the as-exfoliated solution was drop-casted onto the SNP-Ag substrate to form a hybrid SNP-Ag-TaS₂ structure. Rhodamine 6G (R6G) was chosen as the probe molecule, and the R6G solution of 10⁻⁵ M concentration was prepared by dissolving R6G in ethanol. The hybrid substrate of SNP-Ag-TaS₂ was soaked in the R6G solution to allow the R6G molecules to be absorbed onto the surface of the hybrid substrate in an adsorption step 940 of the method 900 (see FIG. 1). The hybrid substrate was then gently dried for measurement. The measurement was performed using a WITec PSTM (Photon Scanning Tunnelling Microscope) equipped with a 532 nm laser (available from Oxford Instruments).

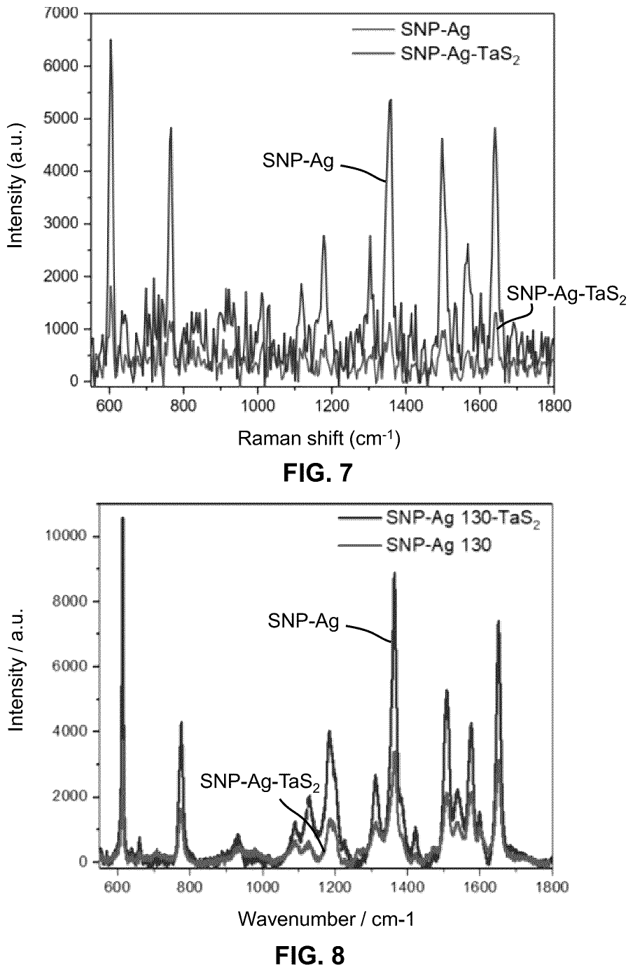

FIG. 7 shows the SERS performance of SNP-AG substrates with a coating of TaS₂ coating (SNP-Ag-TaS₂ and SNP-AG substrates without a coating of TaS₂ coating (SNP-Ag), performed with mild laser intensity. As shown in FIG. 7, the SERS performance of the hybrid substrate is about 4 times higher than the SNP-Ag substrate without TaS₂. The mild laser intensity used in the measurement was relatively low (about 1 mW).

Another batch of samples were fabricated and tested using a stronger laser intensity. FIG. 8 shows the SERS performance of similar substrates of FIG. 7, performed with strong laser intensity. The results as shown in FIG. 8 are consistent with those taken for low laser intensity measurement, i.e., the SERS performance was significantly enhanced by coating TaS₂ onto the SNP-Ag substrate. The abundant density of states (DOS) of TaS₂, the alignment between the Fermi level of TaS₂and the HOMO of the probe molecule R6G, as well as the strong interaction between R6G and TaS₂, promote the charge transfer in this R6G-TaS2 complex, giving rise to the impressive SERS performance.

### Results

It is notable that the proposed SERS substrate 230 has been experimentally verified to outperform the conventional SERS substrate by as much as four times, in terms of the Raman intensity produced. This improvement in sensitivity is one of many factors making the proposed SERS substrate a promising candidate for use in numerous applications, e.g., where trace-level molecular detection is involved. These may include biomolecule sensing, cancer diagnosis, food science, environmental monitoring, catalysis, etc.

The proposed SERS substrate 230 and the proposed method 900 of making the SERS substrate 230 overcome problems with conventional SERS substrates. The proposed SERS substrate 230 enables the use of metal coated SNP without the pitfalls found in conventional metal coated structures. For example, the proposed SERS substrate 230 has a higher degree of reproducibility and greater uniformity. The proposed SERS substrate 230 enjoy the excellent signal reproducibility and high sensitivity without suffering the pitfalls faced by the conventional SERS substrate.

The proposed method 900 enables fabrication over a large area at a relatively low capital outlay, e.g., existing silicon processing equipment can be used.

The proposed method 900 also enables the use of 2D materials in the context of high volume manufacturing. This enables the exploitation of SERS substrates that are based on CM, and opens up new applications made possible by the atomic uniformity and unique electronic structures of 2D materials. Among the metallic/semimetallic 2D materials, metallic TMDC, such as TaS₂, NbSe₂, WTe₂ or other metallic/semimetallic 2D materials, etc., can be used to deliver good performance, with ultralow detection limits and ultrahigh enhancement factors, comparable or better than the best conventional noble metal based EM type SERS substrate.

Alternatively described, embodiments of the present disclosure include a physically simple and but effective hybrid structure for SERS. The proposed SERS substrate 230 integrates metallic/semimetallic 2D material such as TaS₂ with a silver coated SNP substrate. The SERS signals from the TaS₂ coated SNP-Ag substrate are enhanced by several times over those from a SNP-Ag substrate. The metallic/semimetallic 2D materials may be TaS₂, NbSe₂, WTe₂, and/or others. The Ag coated SNP substrate may be fabricated on a Si substrate in blanket plasma etching and e-beam Ag deposition, at wafer scale and low cost. The 2D TaS₂ flakes can be obtained by liquid exfoliation in an easy and mass producible way. The coating of 2D materials onto the SNP-Ag substrate may be done by dip coating, drop casting, spin coating, screen printing, or others.

In some examples, the thickness of the Ag in the SNP-Ag may vary from 20 nm to 200 nm. In some examples, an optimum Ag thickness, such as 130 nm, can be formed to achieve the desired performance for different SNP parameters.

Coating a TaS₂ layer on top of NP-Ag substrates, by combining the power of both SNP-Ag and TaS₂ in SERS can enhance the SERS performance by several times, e.g., by as much as 4 times. This is significant for SERS applications, especially as the proposed method enables the whole fabrication process in large scale, at low cost, and mass producible. This paves the way for the engagement of the proposed hybrid structure in numerous practical SERS applications. SERS applications include: construction, point-of-care application, and analysis algorithms (e.g., data collection for machine learning). Examples include detection of pollutants in environmental analysis, biomarkers-based medical diagnostics, the detection of pesticides in food safety monitoring, detection of explosives in forensic science applications. SERS technology can also be used to provide high sensitivity finger-print detection of materials and molecules.

According to various embodiments of the present disclosure, a SERS substrate includes: a base, an array of nanostructures formed on the base, a first coating disposed on the array of nanostructures, and a second coating disposed on the first coating. The first coating includes a thin film formed of a noble metal. The second coating includes a metallic/semimetallic two-dimensional material.

The metallic/semimetallic two-dimensional material may include one or more transition metal dichalcogenides.

The metallic/semimetallic two-dimensional material may include, but is not limited to, one or more selected from the group consisting of TaS₂, NbSe₂, and WTe₂.

The noble metal may consist essentially of silver.

The first coating may be characterized by a thickness in a range from 20 nm to 200 nm, in which the range is inclusive of 20 nm and 200 nm.

The first coating may be characterized by a thickness of 130 nm.

The array of nanostructures may include a plurality of nanopillars.

The base may include a silicon wafer, in which the array of nanostructures includes silicon nanopillars plasma etched from the silicon wafer.

The array of nanostructures may include a monodisperse array characterized by a nanogap of less than 500 nm between adjacent ones of the nanostructures.

The SERS substrate may include dye molecules adsorbed to the second coating.

According to another aspect, in various embodiments, a method of making a SERS substrate includes steps of: plasma etching a base to form an array of nanostructures on the base; forming a first coating on the array of nanostructures, the first coating being a thin film formed of a noble metal; and forming a second coating on the first coating, in which the second coating includes a metallic/semimetallic two-dimensional material.

In the method, the metallic/semimetallic two-dimensional material may include one or more transitional metal dichalcogenides.

In the method, the metallic/semimetallic two-dimensional material may include, but is not limited to, one or more selected from the group consisting of TaS₂, NbSe₂, and WTe₂.

In the method, the noble metal may consist essentially of silver.

The method may be performed to form the first coating to a thickness in a range from 20 nm to 200 nm, inclusive.

The method may be performed to form the first coating to a thickness of 130 nm.

In the method, the array of nanostructures formed may include a plurality of nanopillars.

In the method, the base may include a wafer, e.g., a silicon wafer, and in which the array of nanostructures may include silicon nanopillars plasma etched from the silicon wafer.

The method may include forming the thin film is formed by electron beam evaporation.

The method may include forming the thin film by thermal evaporation of a noble metal source.

The method may further include: forming a plurality of two-dimensional flakes using electrochemical exfoliation; and depositing the plurality of two-dimensional flakes after the first coating is formed.

In the method, the depositing of the plurality of two-dimensional flakes may be any one process selected from the group consisting of: drop casting, spin coating, dip coating, and screen printing.

The method may include forming the array of nanostructures as a monodisperse array, in which the array is characterized by a nanogap of less than 500 nm between adjacent ones of the nanostructures.

The method may further include adsorbing dye molecules to the second coating.

All examples described herein, whether of apparatus, methods, materials, or products, are presented for the purpose of illustration and to aid understanding, and are not intended to be limiting or exhaustive. Modifications may be made by one of ordinary skill in the art without departing from the scope of the claimed invention.

1. A SERS substrate comprising:
a base;
an array of nanostructures formed on the base;
a first coating disposed on the array of nanostructures, the first coating being a thin film formed of a noble metal; and
a second coating disposed on the first coating, wherein the second coating includes a metallic/semimetallic two-dimensional material.

2. (canceled)

3. The SERS substrate as recited in claim 1, wherein the metallic/semimetallic two-dimensional material comprises one or more transition metal dichalcogenides, and wherein the one or more transition metal dichalcogenides comprises one or more selected from the group consisting of TaS₂, NbSe₂, and WTe₂.

4. (canceled)

5. The SERS substrate as recited in claim 1, wherein the first coating is characterized by a thickness in a range from 20 nm to 200 nm, inclusive, and wherein the noble metal consists essentially of silver.

6. The SERS substrate as recited in claim 5, wherein the first coating is characterized by a thickness of 130 nm.

7. The SERS substrate as recited in claim 1, wherein the array of nanostructures comprises a plurality of nanopillars, wherein the base comprises a silicon wafer, and wherein the array of nanostructures comprises silicon nanopillars plasma etched from the silicon wafer, wherein the array of nanostructures comprises a monodisperse array characterized by a nanogap of less than 500 nm between adjacent ones of the nanostructures.

8-9. (canceled)

10. The SERS substrate as recited in claim 1, further comprising dye molecules adsorbed to the second coating.

11. A method of making a SERS substrate, comprising:
plasma etching a base to form an array of nanostructures on the base;
forming a first coating on the array of nanostructures, the first coating being a thin film formed of a noble metal; and
forming a second coating on the first coating, wherein the second coating includes a metallic/semimetallic two-dimensional material.

12. The method as recited in claim 11, wherein the metallic/semimetallic two-dimensional material comprises one or more transitional metal dichalcogenides.

13. The method as recited in claim 12, wherein the one or more transitional metal dichalcogenide comprises one or more selected from the group consisting of TaS₂, NbSe₂, and WTe₂.

14. The method as recited in claim 11, wherein the noble metal consists essentially of silver.

15. The method as recited in claim 11, wherein the first coating is formed to a thickness in a range from 20 nm to 200 nm, inclusive.

16. The SERS substrate as recited in claim 15, wherein the first coating is formed to a thickness of 130 nm.

17. The method as recited in claim 11, wherein the array of nanostructures comprises a plurality of nanopillars.

18. The method as recited in claim 17, wherein the base comprises wafer comprises a silicon wafer, and wherein the array of nanostructures comprises silicon nanopillars plasma etched from the silicon wafer.

19. The method as recited in claim 11, wherein the thin film is formed by electron beam evaporation.

20. The method as recited in claim 11, wherein the thin film is formed by thermal evaporation of a noble metal source.

21. The method as recited in claim 11, further comprising:
forming a plurality of two-dimensional flakes using electrochemical exfoliation; and
depositing the plurality of two-dimensional flakes after the first coating is formed.

22. The method as recited in claim 21, wherein the depositing of the plurality of two-dimensional flakes is any one process selected from the group consisting of: drop casting, spin coating, dip coating, and screen printing.

23. The method as recited in claim 11, wherein the array of nanostructures is formed as a monodisperse array characterized by a nanogap of less than 500 nm between adjacent ones of the nanostructures.

24. The method as recited in claim 11, further comprising adsorbing dye molecules to the second coating.
